(19) United States
(12) Patent Application Publication
(10) Pub. No.: US 2004/0052315 A1
(43) Pub. Date: Mar. 18, 2004

(54) Multi strata system

(76) Inventors: Jorn Thielecke, Erlangen (DE); Udo Wachsmann, Schwabach (DE); Hans-Dieter Schotten, Nurnberg (DE)

Correspondence Address: ERICSSON INC., 6300 LEGACY DRIVE, M/S EVW2-C-2, PLANO, TX, 75024, US

(21) Appl. No.: 10/399,130

(22) PCT Filed: Oct. 4, 2001
(86) PCT No.: PCT/EP01/11462

(30) Foreign Application Priority Data
Oct. 3, 2000 (EP) 00121621.7

(51) Int. Cl. H04L 27/04; H04L 27/12; H04L 27/20

(52) U.S. Cl. 375/299

(57) ABSTRACT

The invention relates to the field of encoding and deconding multi-layered signals by demultiplexing an input signal into a plurality of subsignals which are encoded differently. To improve capacity the invention proposes to mutually superimpose the subsignals and to apply diversity to each subsignal.

### FIELD OF THE INVENTION

The present invention relates generally to the field of communication systems for example wireless communications, such as cellular radio. The invention particularly relates to the field of encoding and decoding multi-layered signals by demultiplexing an input signal into a plurality of subsignals which are encoded and/or modulated differently.

### BACKGROUND OF THE INVENTION

Spectrum has become a scarce and expensive radio resource. Therefore when designing a radio system and in particular a mobile communication system it is essential to focus on bandwidth and spectral efficiency. Conventionally there used to be a single radio link between a transmitter and a receiver. For the described reasons it became more and more common to equip not only a base station but also increasingly terminals with multiple antennas. Another approach is to dissolve the different delays of signals that have traveled through different channels. This results in multiple-input multiple-output (MIMO) channels.

Such a MIMO channel offers in theory a much greater (channel or link) capacity potential than a single channel with only one antenna at the transmitter and one antenna at the receiver. The crucial question regarding a MIMO channel is how to design a transmission scheme that is capable of exploiting that theoretical capacity potential in practice.

### DESCRIPTION OF THE PRIOR ART

Antenna diversity is a widely known technique to reduce the effects of fast fading, e.g. Rayleigh fading. To benefit from the effect of two or more transmitting antennas the signals that are emitted by each antenna have to be distinct from each other. Early techniques used delays between the antennas to emit identical but time shifted signals or signals that had been encoded in different ways. In order to increase diversity gain and/or to add some coding gain Arthur R. Calderbank disclosed in WO 97/41670 design criteria to construct so-called space-time codes (STC). As the name STC indicates it is a combination of spatial and temporal diversity techniques. Generating different symbols for the same input data and transmitting each symbols over a different antenna effects spatial diversity. Temporal diversity is effected by redundantly transmitting symbols with same information content at different times. Calderbank proposed for generating the symbols either trellis codes having a trellis representation or block codes. This keeps the construction of a corresponding receiver very simple, regardless whether one or more receive antennas are used. Thanks to the trellis structure of the transmitted signal a maximum likelihood decoder like a Viterbi decoder can be used for trellis codes while a simple linear signal processing unit can be used for maximum-likelyhood estimation of the block code symbols.

In Tarokh, Hamid Jafarkhani and A. Robert Calderbank, “Space-Time Block Coding for Wireless Communications: Performance Results”, IEEE Journal on Selected Areas in Communications, Vol. 17, No. 3, March 1999, pages 451-460 a Space-Time block code is defined by a p×n transmission matrix. The entries of the matrix are linear combinations of variables and their conjugates. The elements of a column represent the transmitted symbols of an antenna and the elements of a row represent the elements transmitted at a specific time slot. Decoding can be simplified if the columns of the transmission matrix are chosen such that they are orthogonal.

Alternatively S. Alamouti disclosed in WO 99/14871 a block-coding scheme which for spatial diversity generates symbols that just differ in sign or/and are the complex conjugate of each other. This coding scheme is very simple, as it needs only basic arithmetic operations, such as negation and conjugation. Additionally the symbols are permutated within each block. This coding scheme also allows a simple receiver structure.

It can be shown that the transmission capacity of the described space time coded transmission techniques in the presence of noise signals in best case grows only logarithmically while capacity of an underlying MIMO channel grows linearly with the number of channels or antennas. Because of fundamental information theoretical limits high data rates are only achievable at a high signal to noise ratio (SNR). Assuming such high SNR the difference between the theoretical capacity of the MIMO channels and STC becomes even more significant. This means regarding an application with multiple receive antennas a partially significant reduction in potential data rate has to be accepted.

To make an substantial approach towards the Shannon limit Gerard J. Foschini proposed in EP 0 817 401 A2 a layered space-time architecture employing multi-element antennas. The transmitter for that layered space-time architecture comprises a multiplexer for multiplexing a stream of data received from a source of data into a plurality of substreams of data. These substreams are supplied to modulator/encoder circuits, which may independently encode and then modulate their respective data streams. The encoded substreams are supplied to a commutator, which associates each of the encoded substreams of data with each of a plurality of antenna elements, whereby the association e.g. is for a predetermined duration of time. Thus the association between an output stream of one of the modulators/encoders and an antenna is periodically cycled. The idea is that the encoded data streams share a balanced presence over all transmission paths to a receiver and therefore none of the individual bit streams is contiguously subjected to the worst of all paths. In a simplified version, the periodical cycling is omitted and one layer stream is directly associated with one antenna.

A corresponding digital wireless receiver comprises a plurality of antennas and a bank of conventional RF receiver sections, which interface with the antennas. A preprocessor receives the signals of the antennas as respective signal vectors and eliminates interference between the signal components using nulling and subtraction of previously detected symbols. A Decoder processes the preprocessed signal vectors to detect the constituent data substreams and thus the symbols representing the encoded substreams. The Decoder then supplies the symbols to the preprocessor so that interference from signals already detected may be subtracted from the received signal vector. A multiplexer then multiplexes the substreams to reconstruct the original data stream.

The theoretical gain of that coding scheme that is now named BLAST (Bell Labs Layered Space Time Architecture) looks promising. The transmit signal structure of BLAST implies independent symbols at the antennas. All antenna signals have equal average power and the same code rate if channel coding is applied. Unfortunately recent studies showed that in practical systems the performance of BLAST is limited by error propagation. Especially, for the first antenna signal to be decoded N_{T} receive antenna signals have to be used for interference suppression. That means, that only the difference N_{R}−N_{T} between the number of transmit antennas N_{T} and the number of receive antennas N_{R} remains to exploit receive diversity. Hence, in the case that the number of receive antennas equals the number of transmit antennas N_{T}=N_{R} no diversity is left for decoding the first antenna signal. Thus in most cases the overall performance is determined by the first decoded signal limiting the achievable transmission rate.

### SUMMARY OF THE INVENTION

It is an object of the invention to improve transmission quality in MIMO systems also under bad conditions like poor spatial interference conditions.

This object is achieved by a method comprising the steps of mutually superimposing the subsignals and applying a diversity technique to each subsignal.

By these encoding steps the transmit signal consists of multiple layers. Due to the step of mutually superimposing each superimposed signal contains the full information of each subsignal. By this the input signal is represented in each layer. These especially constructed layers are named in the following as strata to distinguish these strata from the layers known from prior art. To each strata a diversity techniques is applied. As every stratum is associated with a substream of the data stream the strata allow a staged decoding, like for layered space-time encoded signals. Layered decoding is far less complex and almost as powerful as an optimum decoder. The optimal result is achieved if the transmit signal is created thus that a high degree of diversity is achieved for transmission in every stratum, e.g. the superimposition rules are chosen such that they are mutually different.

In contrast to the known layered space time technique, where each data layer is assigned exclusively to one of the N_{T} available transmit antennas, the coding scheme according to the invention constructs the signals of each stratum thus that each stratum stream is transmitted via each transmit antenna. In prior art layered space time technique if one of the transmit antennas is opposed to bad propagation conditions all paths from that antenna are effectively lost. This will result in a total loss of all information transmitted via this antenna, since in prior art technique the data streams are constructed to be independent from each other. Therefore it would not be possible to recover the lost data. However with the coding scheme of the invention the bad conditions for different antennas may be compensated by transmission via other paths since each layer experiences every path. That means with that concept capacity is achievable for a given propagation and disturbance situation.

This coding scheme is a trade off between the degree of repetition compared to prior art space time coding schemes and the number of independent symbols per channel use that shall be achieved. Additionally high diversity is available at the receiver for each signal to be decoded.

In a further embodiment of the invention the transmit signal is adapted to the actual channel conditions in order to enable receiver techniques based on successive decoding with interference cancellation without wasting transmission capacity. Due to the special construction of the signal strata the variation in rate and/or power being signaled back and adapted at the transmitter are significantly reduced. As this coding scheme provides equal channels for all strata, all paths are experienced by every stratum and thus the channel characteristics for each individual stratum are much more balanced.

Preferably each data stream is transmitted on the same power level and only the code rate including size of signal constellation of each data stream is adapted. Same power levels will balance the interference situation at the receiving antennas. If an appropriate coding technique like e.g. space-time coding is used for generating diversity this will also ensure uncorrelated antenna signals. In comparison hereto power adaptation encoders enabling different layer protection levels are more or less a little bit more complicated. Using convolutional codes code rate adaptation may be easily accomplished by puncturing.

For some reasons it might also be considered not to use a feedback channel e.g. if the channel and hence the resolution adaptation changes too fast or in the case of broadcasting information to a plurality of receivers. The individual layer settings are more or less mismatched to the current channel situation. If it is not considered to use a feedback channel, or as a fall-back solution when a feedback channel can not or should not be used momentarily, a possibility to improve decoding performance is to use an iterative decoder. In this case it might also be considered to choose power and code rate at the transmitter to be equal for all data strata.

Different code rates according to the order of decoding are also possible, e.g. the stratum to be decoded first may be given the lowest code rate since interference of all other strata is present and so on. Such different code rates in certain situations will accelerate convergence of iterative decoding.

Due to the signal structure of the proposed coding scheme it could be presumed that every stratum's signal undergoes comparatively similar channel and interference situations. That means available diversity and disturbing interference is similar for all strata. Therefore, in a staged decoding procedure each individual decoder has to cope with similar noise and interference conditions except for the fact that the interference of previously decoded signals may be removed. Thus ideal conditions are provided by the proposed coding scheme to use iterative decoding techniques like the so-called turbo decoding. Such a decoding provides near maximum-likelihood decoding performance with already a few iterations.

E.g. the decoder of the first stratum may experience a channel and interference situation which exceeds its error-correcting capabilities. However, in a second or any further decoding cycle, the first decoder might succeed in providing the transmitted data correctly since the interference of the other strata has been reduced or even cancelled by the individual stratum decoders in a previous cycle.

### BRIEF DESCRIPTION OF THE INVENTION

In the following the invention will be further described according to the figures and by means of examples

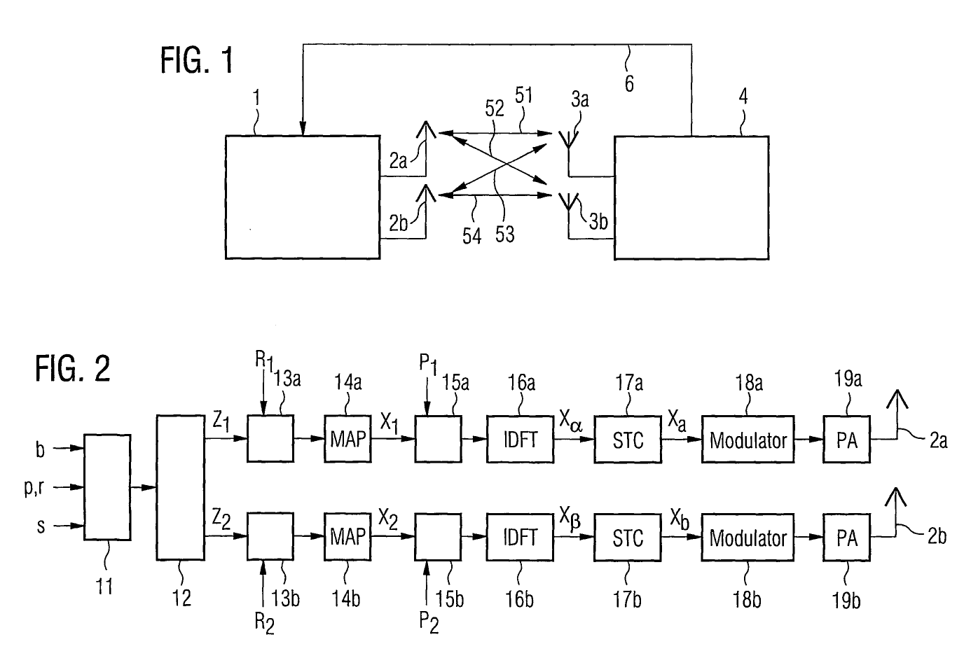

FIG. 1: Block diagram of a MIMO transmitting system

FIG. 2 Transmitter according to the invention with separate encoders

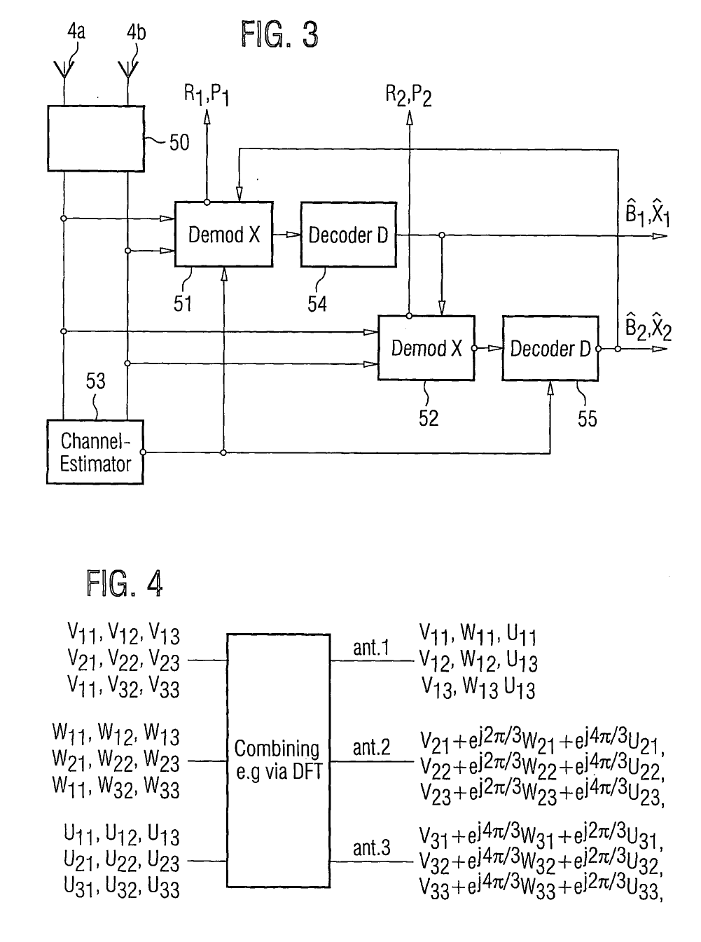

FIG. 3 Receiver according to the invention

FIG. 4 Multi-stratum generation with DFT

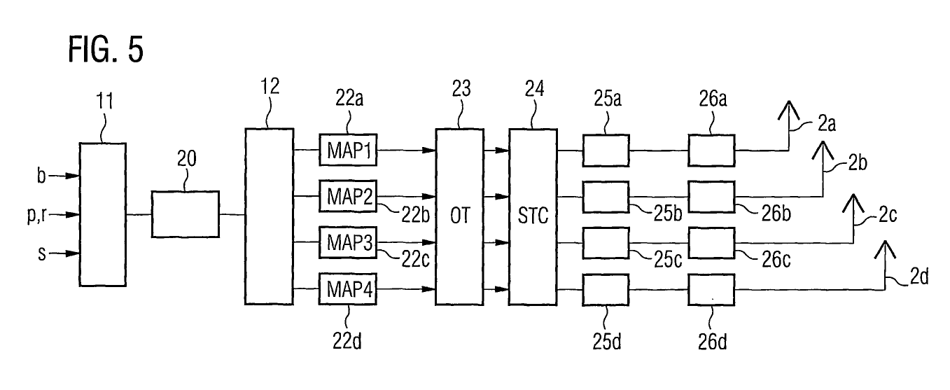

FIG. 5 Transmitter with a single outer encoder

FIG. 6 Multi strata generation on grouped substreams

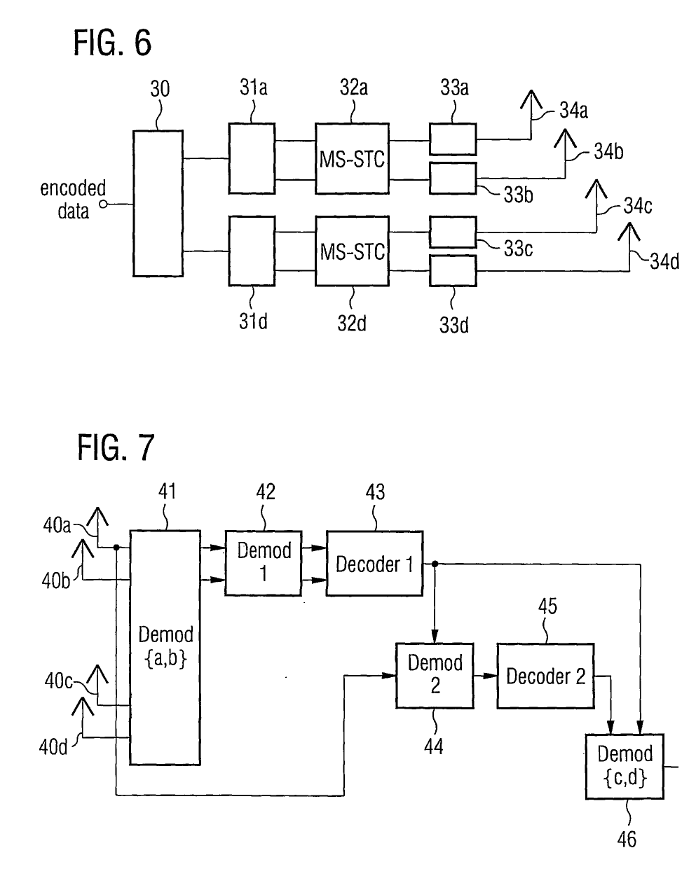

FIG. 7 Receiver structure for grouped Multi strata signals

One aspect of the invention is that the receiver uses layered decoding, that means to give a short outline beforehand that signals of different layers are decoded successively whereby signals of already decoded layers are considered as disturbing interference. For layered decoding in practice it is favourable when the following condition is met

2≦min (N_{R},N_{T})≦N≦N_{T}

where N_{R} represents the number of receiving antennas, N the number of parallel data streams or layers respectively and N_{T} the number of transmitting antennas. Just to be accurate the expression min(N_{R},N_{T}) stands in general for the rank of the channel matrix which has as entries the coefficients of all existing paths. There is no benefit for making N larger than min(N_{R},N_{T}) but the scheme still works. It should be understood that the way of generating a MIMO transmit signal according to the invention is not conditioned on the use of layered decoding. Also when joint decoding techniques are used the advantages of the invention are still present.

In the following description of an embodiment of the invention a configuration that meets the minimum requirements N_{R}=2, N=2 and N_{T}=2 has been chosen for reasons of clarity and conciseness.

FIG. 1 gives a coarse overview of a transmitting system with at least one transmitter 1 and one receiver 4. For bi-directional communication the transmitter 1 and the receiver 4 will be part of transceivers, each providing a transmitter as well as a receiver. In the case of a mobile communication system of course there will be a so-called base station, equipped with a plurality of transceivers for serving a plurality of mobile transceivers. Nevertheless this minimum system is sufficient to explain the invention.

The transmitter 1 emits via two transmitting antennas 2a, 2b signals constructed according to the modulation scheme disclosed by the invention. As in this embodiment at the receiver 4 there are also two receiving antennas 3a, 3b four possible paths 51, 52, 53 and 54 could be distinguished in the multiple input multiple output (MIMO) channels. Further in the first embodiment of the invention a feedback channel 6 is provided. Although this feedback channel is indicated in FIG. 1 only by a single line in a bi-directional transmission system this feedback channel 6 usually will be installed by embedding feedback information into other user information sent back in the other direction. Thus the feedback information may be also sent via MIMO channels.

FIG. 2 shows in more detail those parts of the transmitter 1, which are in direct relation to the invention. Other parts not affected by the invention, like power supply etc. have been omitted for the purpose of clarity. Usually useful data b (e.g. speech coded data or data of a file transfer) to be transmitted to a particular user will be present as a stream of data items, like bits. Depending on the system architecture other data, like control data p, r or signaling data s may be added, e.g. by means of a multiplexer 11 to form a stream of unprotected user data.

This data stream is then demultiplexed by a demultiplexer 12 into a number N of substreams. As already pointed out the number of substreams ideally matches the rank of the channel matrix, which corresponds in most cases to min(N_{R}, N_{T}). In praxis N can be chosen to match the number N_{T} of transmit antennas. In this embodiment accordingly two substreams Z₁ and Z₂ are provided.

By means of channel encoder 13a, 13b redundant information calculated from the user data is added to each substream Z₁, Z₂ for the purpose of improving transmission quality and providing error protection. E.g. in the world wide spread GSM system block convolutional codes, a Fire-code and parity codes are used for this purpose.

The channel encoder 13a, 13b of this embodiment are provided with a code rate adaptation controlled by the receiver 4 via the feedback channel 6. The control values R₁, R₂, which have been received via the feedback channel 6 are used to individually set the data rate of each stratum. As it will be explained later on in more detail the purpose of code rate adaptation is to increase redundancy if a loss in transmission quality is encountered and vice versa.

The design of such a code rate adaptable channel encoder 13a, 13b depends on the available bandwidth of the transmission system. If only a constant bandwidth (=constant data rate of the channel encoded data) is available also the data rate of the source signal has to be reduced to spent the saved data for channel encoding. A technique to adjust the amount of added redundancy is the so-called puncturing. The rate adapted source signal is always encoded with constant redundancy giving a constant error protection. The volume of redundancy could be chosen such that a source signal with a data rate adjusted at the lowest level together with the added redundancy reaches exactly the available transmission data rate. Due to the constant redundancy the overall data rate at a higher source data rate would exceed the available data rate. But as a higher source data rate is admitted because of a higher transmission quality that allows using less error protection some of that redundancy has become superfluous. Therefore specific redundant information can be removed to achieve the available transmission data rate without putting receive quality in jeopardy.

Usually adaptation of speech source data rate is limited or even impossible. Newer communication systems like the third generation partners project (3GPP) have been designed from the beginning with selectable transmission capacities. In a system like this if more error protection is required a central control station for allocating more transmission capacity for a disturbed communication link could handle this request.

For purposes of file transfer an adaptation of the source data rate inmost cases is not as crucial as for speech encoded data. Expanding error protection will of course increase transmission time, but for non-time-critical applications like reading e-mail an increase of transmission time will be tolerated in favor of error free reception.

In mapping units 14a, 14b the output signals of the channel encoders 13a, 13b are mapped to transmission symbols X₁, X₂ stemming from a symbol alphabet e.g. QAM symbols. However this mapping is optional.

In this embodiment power control signals P₁, P₂, which have been received via the feedback channel 6 are used in power control units 15a, 15b to control individually the power level of each stratum.

The symbols of each data substream X₁, X₂ are grouped ongoing into data elements x₁₁, x₁₂, . . . and x₂₁, x₂₂, . . . Every two data elements x₁₁, x₁₂ and x₂₁, x₂₂ of each substream are combined to form data vectors X₁, X₂

X₁=[X₁₁,X_{12]}

X₂=[X₂₁,X_{22]}

The data vectors X₁, X₂ then are mutually superimposed by means of superimposition transformers 16a, 16b to two superimposed vectors X_{α}, X_{β} before space-time coding. Space-time coding, or in general every diversity achieving scheme relies on the fact that replicas of one data vector are transmitted in different manners and the results are combined appropriately at the receiver.

The purpose of superimposition is that at the input of the following diversity encoder, e. g. a space-time block encoder, N independent data vectors are provided. To be more specific, a space-time encoder can conventionally be viewed as generating N_{T} output streams, each of which is a function of a single input stream. For a more illustrative explanation of the invention it is advantageous to view the conventional space-time encoder as processing N_{T} identical data streams. If N is less than N_{T} the remaining N_{T}−N input vectors may be filled by arbitrary copies out of the independent N ones. However, it is important that with respect to an individual data vector, e.g. X₁, the input vectors to the diversity encoder are again replicas of each other maybe except for some phase shifts or other modifications if all other data vectors are set to zero. By this kind of superimposition the original diversity achieving features of any diversity encoder are preserved.

Preferably for superimposition an orthogonal transformation is used, since it ensures that the input vectors at the following diversity encoder are uncorrelated and an orthogonal transformation will make it easier to separate the superimposed data substreams at the receiver. For the two vectors X₁, X₂ of this embodiment an orthogonal superimposition for example will give

x_{α}=[x₁₁+x₂₁, x₁₂+x₂₂]

x_{β}=[x₁₂−x₂₂, x₁₁−x₂₁]

As it is known an orthogonal transformation can be achieved by an inverse discrete Fourier transform (IDFT), a Walsh transform or a Hadamard transform just to list some possibilities. By this the superimposition takes place along the spatial dimension. That means, only symbols from the same time instant are involved in the transformation.

It should be clear that in order to achieve uncorrelated symbols in the input vectors of the space-time encoder also superposition along the time axis is possible. Then, only symbols belonging to the same transmit antenna are involved in the transformation. This yields in the above-described example:

Xₐ=[x₁₁+x₂₁x₁₂−x₂₂]

X_{b}=[x₁₂+x₂₂x₁₁−x₂₁]

In the following, only the first version of superposition along the spatial dimension is further developed.

The invention is so far primarily described for the case when signal streams for the orthogonized vectors Xα,Xβ are then input each to diversity encoders 17a, 17b giving two encoded vectors Xa, Xb, the elements of which form transmit symbols that are fed to modulators 18a, 18b. As in the embodiment of the invention a space-time block code according to Alamouti has been chosen the values of the encoded vectors are

Xₐ=[x₁₁+x₂₁,−(x₁₂+x₂₂)*]

X_{b}=[x₁₂−x₂₂, (x₁₁−x₂₁)*]

where the “*” denotes a complex conjugate. Thus the encoded vectors Xₐ, X_{b} comprise overlapped space-time encoded replicas of the original data vectors X₁, X₂ but differently modified such that orthogonality between all data vectors is ensured. As it can be easily seen due to the combination of replication and orthogonality the four transmit symbols

S₁₁=x₁₁+x₂₁

S₁₂=−(x₁₂+x₂₂)*

S₂₁=x₁₂−x₂₂

S₂₂=(x₁₁−x₂₁)*

are independent of each other.

The symbols S₁₁, S₁₂, S₂₁, S₂₂ are then fed to two modulators 18a, 18b, one for each transmitter branch. Each power adapted stratum signal is then amplified by separate power amplifier 19a, 19b and emitted by two transmit antennas 2a, 2b.

With the described combination of orthogonal superimposition and replication the repetition nature of diversity signals is no longer present in the symbols as long as N=N_{T}. Thus the major drawback with respect to the achievable peak data rate e.g. of conventional STC is overcome. In principle, the capacity of this coding scheme for N_{T}=2 is equal to the capacity of the underlying MIMO channel at least if P₁=P₂. For more than two transmit antennas N_{T}>2 fully orthogonal STC will cause a rate loss. However, the increase in capacity is still linear whereas STC for itself will offer only a logarithmic increase. Additionally, the invention is still applicable if quasi-orthogonal space-time coding schemes like those proposed by Jafarkhani are used as basic diversity encoders. Those techniques may avoid the rate-loss problem.

It also has been evaluated that is also possible to encode the channel-coded data streams first by a diversity encoder and then to apply the (orthogonal) superimposition. The resulting symbols may be different, so that this has to be taken into account in a corresponding receiver but the general advantage is preserved. Although in this example a space-time block code has been applied also a space-time trellis code will offer the same effect or any other diversity scheme like delay diversity.

A receiver adopted for the described coding scheme will make use of a modified layered decoding. Layered decoding, as known from BLAST means that firstly a first data vector X₁ is decoded treating the other data vectors X₂ as disturbing interference. After that first data vector X₁ is decoded, the corresponding part of the receive signal related to that first data vector X₁ is subtracted from the receive signal of the antennas. Thus the remaining receive signal consists only of the remaining data vectors. In the described case, where the transmit signal is constituted by only two independent data vectors the remaining data vector already corresponds to the second data vector X₂. In general for N>2, the number of interfering signals decreases by one for every decoded stratum. Only the last stratum may be decoded without interference.

For recovering the originally sent information a conventional receiver with an appropriate decoder may be used. As a person skilled in the art is familiar with the construction of a conventional receiver only a coarse description of such a conventional receiver is given.

FIG. 2 shows a first embodiment of a receiver that is adapted for the described coding scheme. To optimize transmission capacity over a current channel situation the receiver of the first embodiment is based on adaptation of transmission parameters using a feedback channel to the transmitter.

The receive signals of each antenna 4a, 4b are processed in a RF receiving module 51 in the usual way, e.g. filtering, amplifying etc. for getting a data stream Y₁, Y₂ of samples for each antenna signal. As already mentioned a resolvable data stream may result from separate antennas or from resolution of separate signal propagation paths, e.g. in a so-called RAKE receiver or any combination of this. These data samples are fed to separate demodulator units 51, 52, one for each resolved data signal. A channel estimator 53 provides channel coefficients that describe the estimated properties of each resolved data signal. Each demodulation unit 51, 52 uses these channel coefficients to compensate distortions introduced by each separate data signal.

For the decoding of Multi Strata—Space Time Coded (MS-STC) signals layered decoding is most convenient. Each demodulation unit 51, 52 pre-processes said receive signal samples Y₁, Y₂ prior to decoding them in separate decoders 54, 55. The pre-processing includes the space-time decoding and appropriate precompensation of the demodulated signals for channel decoding, e.g. an MMSE or a ZF approach may be chosen for suppressing the interference from other strata. Dependant on the actual implemented demodulation scheme, each channel seen from a decoder point of view is different. This so-called equivalent channel, which may be essentially characterized by its signal-to-noise ratio, defines the required transmission parameters for optimal exploitation of the respective transmission channel. In this embodiment the respective code rate R₁, R₂ and the respective transmission power levels P₁, P₂ are used as parameters. These parameters are evaluated by the respective demodulation units 51, 52 and are transmitted to the transmitter by means of feedback channel 6.

At first the first demodulating unit 51 demodulates the received signal to get a preliminary estimation for the first vector X₁. This estimated Vector is then decoded in the first decoder 54 to get estimations of data elements of the first data vector X₁. These estimated first data vectors are input to the second demodulator 52. The second demodulator is using the estimated values of the first data vector X₁ to calculate a compensation signal which is subtracted from the received signal in order to compensate those signal parts that originate from the first data vector X₁. Then the extracted signal is pre-processed according to the channel estimation giving an estimation for the second superimposed data stream of the transmitted signal. The second decoder 55 decodes an estimation for the data elements of the second data vector X₂.

The described decoding process may be repeated in an iterative manner in the case the channel varies too fast so that the adaptation can not follow or in the case there has no adaptation been implemented. E.g. power/code rate adaptation could be used only for one transmission direction, e.g. in down-link and in the other direction e.g. in up-link confidence is placed in iterative decoding. E.g. by this the more sophisticated techniques like adaptive rate encoders and iterative decoding is concentrated in a base station whereas the complexity in the mobile terminals could be kept relatively low.

The purpose of the Multi Strata approach is also achieved if the diversity technique is applied at first to the substreams and then the resulting substreams are mutually superimposed. For FIG. 2 that means that the order of the superimposition transformers 16a, 16b and Space Time Coders 17a, 17b are reversed. Although the achieved effect is the same the resulting transmit signals are different and have to be considered correspondingly in the receiver.

Further advantageous application fields of the invention are orthogonal frequency-division multiplexing (OFDM) based transmission systems like the so-called HIPERLAN/2. In OFDM, the output symbols of a channel encoder are modulated onto sub-carriers being orthogonal to each other. There are in general two possibilities to apply the invention to OFDM. One possibility is to apply said transmit symbols S₁₁, S₁₂, S₂₁, S₂₂ of each stratum in time direction, e.g. to use a single sub-carrier for each encoded vector Xₐ, X_{b} and to transmit the different transmit symbols one after another. For example according to the foregoing example with two transmit antennas the transmit symbols S₁₁, S₁₂ of the first encoded vector Xₐ are transmitted alternately via a first transmit antenna whereas the transmit symbols S₂₁, S₂₂ of the second encoded vector X_{b} are transmitted alternately via the second transmit antenna. To benefit from the space time coding effect the same sub-carriers should be used for the different transmitters. This is the preferred solution for quasi-static channels.

The other possibility is to apply the transmit symbols in frequency direction, e.g. to use as many sub-carriers as transmit symbols are provided for an encoded vector. Thus the transmit symbols of each encoded vectors are transmitted simultaneously via different sub-carriers. As by this the transmit time of a data vector X is reduced to symbol time this transmitting method is most suitable for fast varying transmit channels. To ensure a maximum of identical channel properties preferably neighbored sub-carriers should be used. Adjacent channels usually stand for the best chance of experiencing essentially the same channel attenuation and phase shift. Of course for special conditions a combination of these two possibilities may give the best trade-off result.

Another application field of the invention is the field of code-division multiple access (CDMA) systems. In CDMA systems the transmitted signals can be time synchronized on a symbol level. Often orthogonal spreading codes are used to separate the data of different user. For the following embodiment of the invention one symbol is transmitted per spreading code. For example the symbol can be a BPSK, QPSK, or any QAM or PSK symbol. Already known systems like the 3^{rd} generation partnership project (3GPP) Wideband-CDMA (W-CDMA) provide a set of orthogonal codes with different code lengths to support different data rates for different users and applications. Due to orthogonality the number of available spreading codes is limited. Spreading codes of shorter length, which allow to support higher data rates, block an accordingly larger part of the available spreading codes. Due to the nature of 3GPP the system capacity in the down-link suffers above all from the limited availability of orthogonal codes. Often a minimum spreading factor is defined since for example a minimum number of common control channels need to be transmitted in parallel to the user's signal. But this results in a limitation of the data rate available for each user. As a way out 3GPP provides the so-called multi-code transmission where a user is assigned more than one orthogonal code. The data stream of a user is serial to parallel converted and the parallel data streams are used to modulate the orthogonal codes assigned to the considered user.

Usually, if for example one symbol is transmitted per spreading code, the multi-code scheme allows transmitting L symbols per spreading code period using L orthogonal codes. At the time it is discussed to space-time encode the multi-code signal and transmitted these signals via two antennas. Using two antennas L/2 symbols are transmitted by each of the two antennas per spreading code using L orthogonal codes. The space-time coding scheme may be applied on each sub-signal before modulation with the orthogonal codes and summing up all different signals or the space-time coding may be applied to the multi-code signal.

The invention proposes to use multi-stratum scheme applied to only one spreading code instead of using the multi-code scheme as long as the number of available orthogonal codes L is less or equal to the number K of antennas. In case L is greater than K ceil(L/K)+1 orthogonal codes are used for the considered user. On each orthogonal signal the multi-stratum scheme is applied.

With this combination of the MSSTC scheme and the multi-code scheme, L symbols are transmitted per spreading code period and per antenna using ceil(L/K)+1 orthogonal codes. Thus, for the same user data rate a smaller number of orthogonal codes is blocked—or for the same number of available orthogonal codes a higher data rate is supported. Alternatively, the spreading factor used can be increased still supporting the same data rate and blocking the same part of the orthogonal spreading codes.

In the following as an example K=2 antennas and spreading codes of spreading factor SF=4 are used. With L=2 orthogonal codes for the considered user, two symbols are transmitted per antenna and per code period. Using the known scheme by this half of the available orthogonal codes are blocked for transmission. Applying the MSSTC scheme according to the invention with the same data rate per antenna only one orthogonal code, i.e. 25% of the available codes has to be used. Using two orthogonal codes of spreading factor SF=8 and applying the MSSTC scheme independently on both orthogonal codes only 25% of the orthogonal codes have to be used for the same data rate per antenna. Alternatively applying the MSSTC scheme independently on each orthogonal code using the same percentage of orthogonal codes the data rate may also be doubled.

It is important to note that the presence of multiple receive antennas is not a prerequisite to have MIMO channels. In general, the MIMO channel is characterized by the number of resolvable wave field components of the emitted signal. Therefore; e.g. multiple transmit antennas in a CDMA system together with a multipath propagation and a RAKE receiver constitute a MIMO channel as well. Although in the embodiments multiple receive antennas have been taken to describe the invention, it should be well understood that the invention applies to every MIMO channel.

The dimensionality of the channel is equal to the rank of the channel matrix, In a MIMO environment the channel dimensionality will be greater than one in most cases. But if the channel has a dimensionality greater than one, then it is a waste of capacity to use a transmit signal with repetition structure. In general if the dimensionality of the transmit signal is lower than the dimensionality of the channel then the channel is not optimally exploited or in other words the capacity of the channel may not be achieved. Therefore any transmit signal containing a repetition structure does not achieve capacity.

The multi-stratum approach of the invention may be used to increase the dimensionality of the transmit signal by achieving independence among the symbols being transmitted via different antennas. At the same time the structure originally imposed on the transmit signal and by this the essential properties are retained in the individual strata. That means that e.g. the same receiver algorithms may be used in the individual strata as before while the spectral efficiency of the transmission scheme may be increased.

FIG. 4 shows an embodiment of a further superimposition transformer for a transmitting system with three antennas, e.g. N=N_{T}=N_{R}=3. While the symbols at the input of a combiner may contain dependencies within one transmit block, consisting in this embodiment of nine symbols along the antenna axes, this dependencies are removed at the output of the combiner because the combiner is based on an orthogonal transformation, here the Discrete Fourier Transformation (DFT). It should be emphasized that combining is not necessarily equal to DFT, it is only based on the DFT principles. The symbols at the first antenna Y₁ are combined with a mutual phase shift of zero, the symbols of the second antenna Y₂ with 2π/3 and the symbols at the third antenna with 4π/3. However, it need not be a DFT, any other orthogonal transformation may be used to create such a multi-stratum signal. The created multi-stratum signal has a dimensionality of three and matches perfect to a channel of dimensionality three. If the channel has a lower dimensionality N, e.g. N=2 then N=2 strata are sufficient as well.

The invention is not restricted to the case where the stratum signals are encoded separately. Therefore, a further embodiment is shown in FIG. 5, where an outer code is used. The data stream containing user information, control, and signaling data is first encoded by use of a binary code in an encoder 20. The coded bits are fed to a demultiplexer 21, which distributes them to four stratum bit streams. The stratum bit streams are mapped to modulation symbols e.g. QAM symbols by signal mappers 22a, 22b, 22c, 22d. In general, the modulation alphabets per stratum may be different, e.g. bits of stratum a are mapped to QPSK while bits of stratum b are mapped to 16QAM symbols, etc. . . . This implies also that the demultiplexer 21 does not necessarily distribute the encoded bits equally among the strata. After the signal mappers 22a, 22b, 22c, 22d the complex symbols are treated as before in the previous embodiment with inner coding. This means they have to be mutually superimposed by a superimposer transformer 23 and then diversity encoded, e.g. by a space-time coder 24 before being modulated by modulators 25 and power amplifier 26 in separate branches of a transmitter before being transmitted via four separate antennas 2a, 2b, 2c, 2d.

It should be emphasized that by the outer-code version of MS-STC it is still possible to establish different protection levels for the individual strata This facilitates layered decoding because it mitigates the effect of error propagation due to erroneous decisions.

The receiver for an outer-code MS-STC looks very similar to the original one in FIG. 3 except for two items. All detector output signals are collected and processed jointly by one channel decoder after the staged detection procedure. The decoding unit within the staged loop is replaced by a simple decision unit, which decides on the transmitted stratum symbol based on the raw detector output. In an advantageous embodiment all modulation alphabets are chosen equally. In this case the modulation unit is the same for all strata and can thus be placed before the demultiplexer.

A further embodiment depicted in FIG. 6 shows that the multi-stratum approach may also be applied individually to multiple portions of the transmitted signal when these portions are subject to repetition. Such a transmit signal with individual portions containing repetition is generated by the so-called ML-STC. In order to show the principles, a description of ML-STC for the case of four transmit antennas is sufficient. However, the invention is not limited to this case.

The core of ML-STC is that the four transmit antennas are grouped into two pairs 34a, 34b and 34c, 34d. A basic data stream consisting of user, control and signaling information is demultiplexed by a demultiplexer 30 into two data streams, each of which is dedicated to a pair of transmit antennas. The two data streams are further demultiplexed by sub-demultiplexer 31a, 31b in groups of two substreams each. In this embodiment, as a group consists of two substreams, these group is named a pair of substreams. Each pair of substreams is MS-STC encoded separately by MS-STC encoders 32a, 32b into two layer data symbol streams. It should be understood that the principle of outer coding can be applied here as well. Space-time coding targeted at two transmit antennas is applied separately to the two encoded layer symbol streams. The two output symbol streams from the STC unit of the first layer are then associated with the first antenna pair 34a, 34b while the STC symbols of the second layer are associated with the second antenna pair 34c, 34d. Modulation and power amplifying is depicted by the blocks 33a, 33b, 33c, 33d which are inserted between the MS_STC encoders 32a, 32b and the antennas 34a, 34b, 34c, 34d. It should be mentioned that the way of grouping the antenna pairs does not affect the scheme itself. Any possible antenna pairs can be used.

The resulting transmit signal has repetition elements only within the respective antenna pairs. Symbols across the antenna pairs are independent. Therefore, the multi-stratum approach shall now be applied only within one layer bit for each layer separately. That means the portion of the transmitter comprising one individual layer data stream after demultiplexing up to the symbols transmitted from one pair of antennas is viewed as a separate transmission chain where one data stream is to be transmitted from two antennas by means of space-time coding. Within each separate transmission chain, the multi-stratum approach is then applied in order to maximize the achievable capacity.

A corresponding receiver to this embodiment is depicted in FIG. 7. The first step in baseband is to demodulate the signal from the first antenna pair 40a, 40b while suppressing the signal from the second antenna pair 40c, 40d acting as interference in a first demodulator unit 41. After demodulation the remaining interference from the second antenna pairs 40c, 40d treated as white noise and no longer specifically considered. That means that after the first demodulation a conventional staged decoding in a first decoder 43 with two-stratum decoding as described in previous embodiments takes place. After having decoded the two strata which belong to the first antenna pair 40a, 40b, the impact of the symbols transmitted from the first antenna pair 33a, 33b are removed by interference cancellation. The remaining part is detected in a second demodulator 44 and decoded in a second decoder 45 as if only a two-antenna two-stratum system is present, which is extensively described above.

It should be mentioned that one way of improving the decoding performance of ML-STC is to introduce sorting, i.e. to determine the optimum order in which the two layers or antenna pairs are going to be detected and decoded. This enhancement is also possible if multi-stratum is applied in addition to ML-STC.

The invention is so far primarily described for the case when signal streams for transmission over physical antennas shall be created. It should be however understood that the invention is also applicable when the signal streams are fed to multiple beam forming units rather than to multiple transmit antennas. The number NT, which is used throughout this invention usually for the number of transmit antennas, is then to be interpreted as the number of available beams. A beam forming unit distributes the incoming signal stream over in general multiple transmit antennas by application of dedicated steering vectors. For example, in the eigenbeamforming concept published by Nossek, Siemens, the steering vectors correspond to the eigenvectors of the spatial correlation matrix R_Tx at the transmitter side, namely R_{Tx}=E{H^{H}H}, where H is the channel matrix.

1. A method for coding an input signal to generate a plurality of output signals that are foreseen to be emitted by a plurality of antennas, each output signal contains a number of symbols, the method comprising the steps of
demultiplexing the input signal into a plurality of subsignals,
mutually superimposing the subsignals, such that the symbols after mutually superimposing are uncorrelated,
applying diversity to each subsignal.

2. A method according to claim 1 where the step of mutually superimposing the subsignals is done before the step of applying diversity.

3. A method according to claim 1 where the step of applying diversity is applied first and then the step of mutually superimposing the subsignals is applied after the step of applying diversity.

4. A method according to claim 1, 2 or 3 where the subsignals are encoded separetly.

5. A method according to claim 1, 2 or 3 where the input signal is encoded prior to demultiplex it into separate substreams.

6. A method according to claim 1, 2, 3, 4 or 5 wherein for superimposing the subsignals an orthogonal transformation is used.

7. A method according to claim 1, 2, 3, 4, 5 or 6 wherein for applying diversity to the subsignals a space-time code is used.

8. A method according to claims 1 to 7 wherein the transmit signal is adapted to the actual channel conditions by means of a feedback signal (6).

9. A method according to claims 1 to 8 wherein for adaptation different code rates (R₁, R₂) according to the order of decoding are used for encoding.

10. A method according to claims 1 to 9 wherein for adaptation the transmit power is set to different levels (P₁, P₂).

11. A method according to one of the preceeding claims wherein the substreams are emitted via more than one antenna (2a, 2b).

12. A method according to one of the claims 1 to 11 wherein orthogonal frequency-division multiplexing is used for transmitting the different substreams.

13. A method according to one of the claims 1 to 11wherein the method is applied to orthogonal signals of a code multiplex system.

14. A method according to one of claims 1 to 13 wherein the input signal is demultiplexed into first subsignals, the subsignals are further demultiplexed to groups of subsignals and only the groups of subsignals are mutually superimposed within their group.

15. A transmitter with a processing unit carrying out the method according to any of the claims 1-10.

16. A receiver for decoding a receive signal which has been generated according to a method of claims 1 to 6 wherein the decoder uses a decoder that corresponds to the diversity coder used in the transmitter.

17. A receiver according to claim 16 wherein the decoder makes use of iterative decoding.

18. A receiver according to claim 16 or 17 wherein the decoder generates a feedback signal for adapting code rate and/or power level of a transmitter.
